(19) United States
(12) Patent Application Publication
(10) Pub. No.: US 2002/0181541 A1
(43) Pub. Date: Dec. 5, 2002

(54) TEMPERATURE INDICATOR EQUIPPED POT COVER

(76) Inventor: Chih-Hsiung Lee, Pan-Chiao City (TW)

Correspondence Address: SUPREME PATENT SERVICES, POST OFFICE BOX 2339, SARATOGA, CA, 95070, US

(21) Appl. No.: 09/875,704

(22) Filed: Jun. 5, 2001

(51) Int. Cl. G01K 1/14; G01K 13/00; G01K 5/62

(52) U.S. Cl. 374/141; 374/207

(57) ABSTRACT

A temperature indicator equipped pot cover is built by adding a temperature measurer to a generic pot cover body dexterously to keep a cook always informed of the temperature of the cooking food for raising efficiency and shortening cooking time and for energy saving and careless scald prevention.

### FIELD OF THE INVENTION

This invention relates generally to pot covers, more particularly, it relates to a temperature indicator equipped pot cover, which functions as a generic pot cover on the one hand and shows the temperature inside a cooking pot on the other hand for improvement of the quality and efficiency and avoid people's careless scald when cooking food.

### BACKGROUND OF THE INVENTION

In order to raise cooking efficiency, a pot is usually paired with a pot cover having a pot knob for easy handling. During cooking, a cook or a housewife is supposed to open the pot cover from time to time to inspect and make sure if everything is under control because no reference temperature indication is available. By doing so, the cook or the housewife may need a longer time to set the food ready and run the risk of being scalded when he/she opens the pot cover for inspection.

Whereas in the case of an average pressure cooker which is heated to create pressure inside for accelerating the cooking speed, there is a hidden danger of explosion when the internal pressure raises to exceed a rated value. Hence, for security purpose, a user may adjust or even cut off the fuel supply under such a situation according to an attached temperature indicator of this invention.

### SUMMARY OF THE INVENTION

The primary object of this invention is to provide a temperature indicator equipped pot cover, which is built by adding a temperature measurer to a generic pot cover body dexterously to keep a cook always informed of the temperature of the cooking food for raising efficiency and shortening cooking time and for energy saving and careless scald prevention.

A secondary object of this invention is to provide a temperature indicator equipped pot cover, which is applied to a pressure cooker to show inside temperature for a cook or a housewife to adjust temperature in time, accordingly the inside pressure, to thereby eliminate risk of explosion and avoid scald owing to carelessness.

Another secondary object of this invention is to provide a temperature indicator equipped pot cover, which can display inside temperature of a pot rapidly and correctly by extending a sensing portion of a temperature measurer deep into a position underneath the pot cover.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a cutaway sectional view of a temperature indicator equipped pot cover of this invention;

FIG. 2 is an exploded view of the pot cover of this invention in three dimensions; and

FIG. 3 is an enlarged partial view of a cutaway section of this invention.

### DETAILED DESCRIPTION OF THE INVENTION

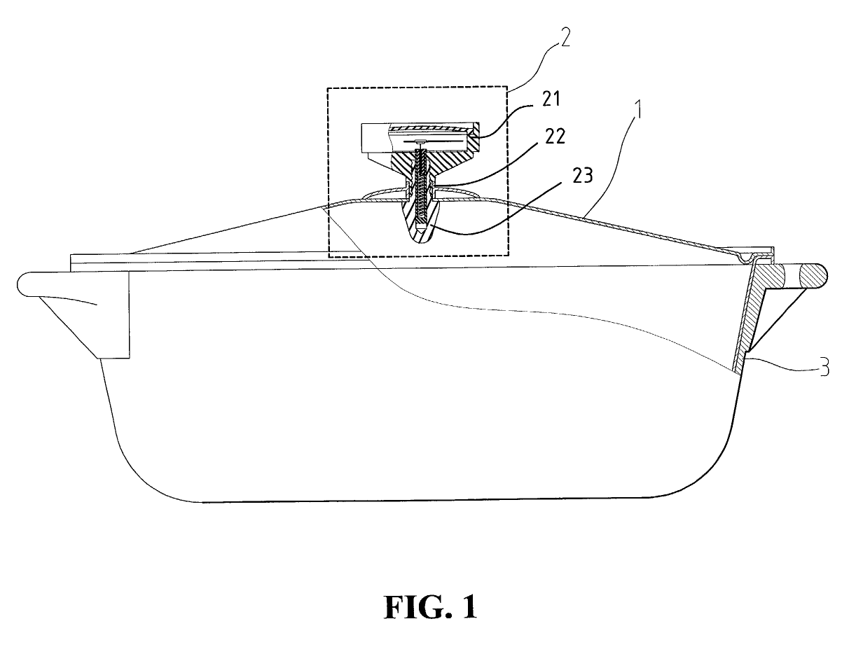

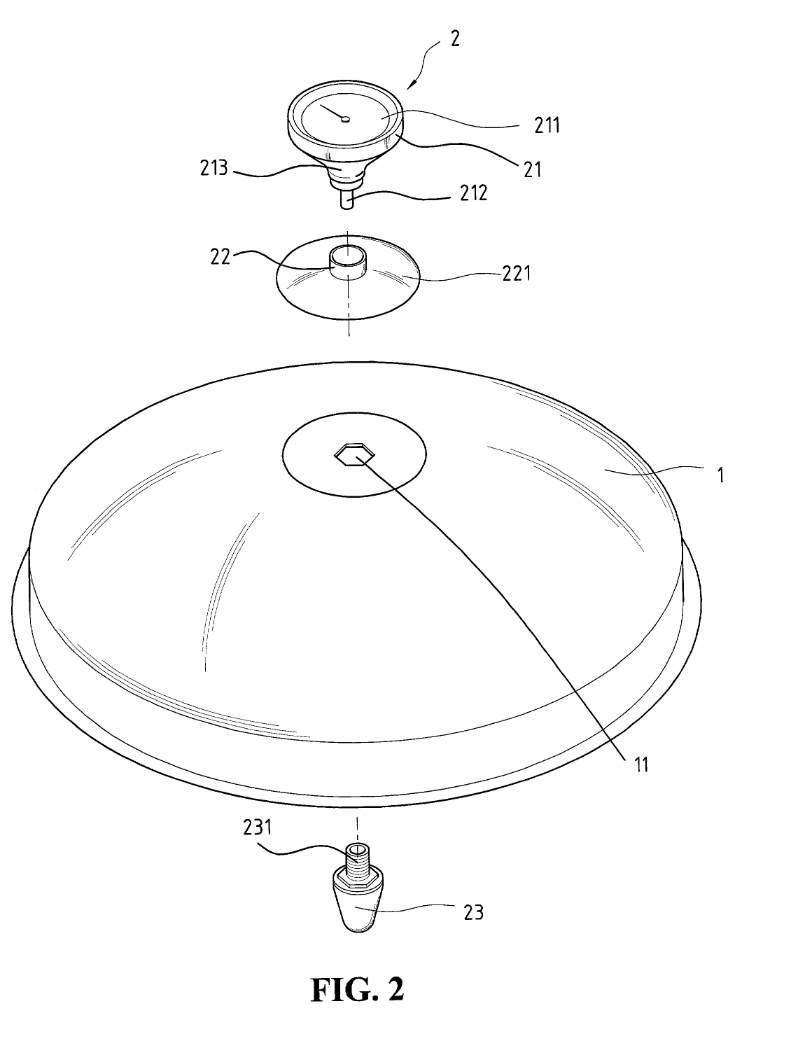

As indicated in FIGS. 1 and 2, a temperature indicator equipped pot cover of this invention is composed of a pot cover body 1 and a temperature measurer 2, wherein a through hole 11 is formed in center of the top portion of the pot cover body 1 for disposition of the temperature measurer 2.

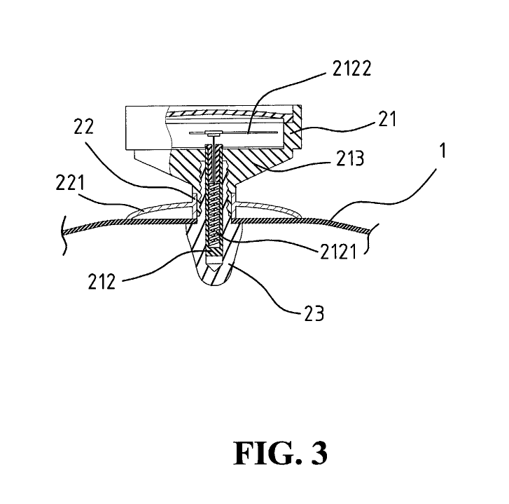

The temperature measurer 2 further comprises a thermometer 21, a coupling pad 22, and a thermal sensing head 23. The thermometer 21 is a mechanical sensing thermometer, wherein a temperature dial 211 is arranged at its top end; and a bottom end of the thermometer 21 is extended downwardly to form a metallic temperature sensing portion 212 which is provided with a sensing strip 2121 (shown in FIG. 3), which is thermally expanded to move a pointer 2122 to show a quantified degree in the temperature dial 211. The bottom verge of the thermometer 21 is a conic cover knob portion 213 made of a high-temperature resistible and poor thermal conductive material, such as heat-resistant rubber, bakelite, etc., for holding the pot cover body 1 to open a pot without being scalded.

Basically, a generic pot cover is dexterously combined with a thermometer to form the temperature indicator equipped pot cover of this invention that occupies a miniature space only with a harmonic configuration. Besides, the cover knob portion 213 is internally threaded for engagement of the thermal sensing head 23 made of a material of good thermal conductivity, which is a hollow body having an external thread 231 formed at its top end for fixedly setting the thermometer 21, and on the other hand, for extending the temperature sensing portion 212 downwardly into the inner space of a pot (the cooking space of pot 3) so as to fully sense the temperature inside the pot.

The coupling pad 22 is in form of a hollow cylinder surrounded by a parabolic annular piece 221, wherein the inner diameter of the coupling pad 22 is correspondent with and sleeve-jointed peripherally to a relatively shorter outer diameter of the conic cover knob portion 213. The coupling pad 22 is also made of a high-temperature resistible material in poor thermal conductivity for the purposes of:

(a) Stabilizing the entire architecture of this invention at the pot cover body; and

(b) Preventing a cook's hand from being scalded when he/she grasps the pot cover knob to open the pot for inspection.

In short, the pot cover of this invention with temperature indicator is built by adding a temperature measurer to a generic pot cover body dexterously to keep a cook always informed of the temperature of the cooking food for raising efficiency and shortening cooking time for energy saving and for preventing accidents.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A temperature indicator equipped pot cover, comprising:
a pot cover body having a through hole at its top end; and
a temperature measurer further comprising a thermometer, a coupling pad, and a thermal sensing head, wherein a temperature dial is arranged at a top end of the thermometer; the thermometer is extended downwardly to form a metallic temperature sensing portion; a bottom verge of the thermometer is a conic cover knob portion in relatively larger scale; the coupling pad is sleeve-jointed to the cover knob portion peripherally; the thermometer and the coupling pad both are disposed at the top end of the pot cover body; the thermal sensing head at the bottom end of the temperature measurer is jointed with the cover knob portion of the thermometer; and the temperature sensing portion of the thermometer is extended into the thermal sensing head.

2. The pot cover according to claim 1, wherein the coupling pad is in form of a hollow cylinder surrounded by a parabolic annular piece, wherein the inner diameter of the coupling pad is correspondent with and sleeve-jointed peripherally to a relatively shorter outer diameter of the conic cover knob portion.

3. The pot cover according to claim 1, wherein the cover knob portion is made of a high-temperature resistible and poor thermal conductive material.

4. The pot cover according to claim 1, wherein the coupling pad is made of a high-temperature resistible and poor thermal conductive material.

5. The pot cover according to claim 1, wherein the thermal sensing head is a hollow body having an external thread at its top end to be engaged with an inner thread formed at a bottom end of the cover knob portion of the thermometer.

6. The pot cover according to claim 1, wherein the thermal sensing head is made of a good heat conductive material.
